(19) United States
(12) Patent Application Publication
(10) Pub. No.: US 2016/0279850 A1
(43) Pub. Date: Sep. 29, 2016

(54) VALVE MOTOR DEVICE OF INJECTION MOLDING APPARATUS

(71) Applicant: YUDO CO., LTD, Gyeonggi-do (KR)

(72) Inventors: Won Sik LEE, Seoul (KR); Hyung Woo LEE, Incheon (KR)

(21) Appl. No.: 15/036,643

(22) PCT Filed: Oct. 23, 2014
(86) PCT No.: PCT/KR2014/010001

§ 371 Date: May 13, 2016

(30) Foreign Application Priority Data
Nov. 13, 2013 (KR) 10-2013-0137849

(51) Int. Cl. B29C 45/28; H02K 7/06; F16K 31/04; H02K 11/215

(52) U.S. Cl. CPC B29C 45/281; H02K 11/215; H02K 7/06; F16K 31/046; F16K 31/047; B29C 2045/1794

(57) ABSTRACT

A valve motor device of an injection molding apparatus is provided. The valve motor device of an injection molding apparatus, which drives a valve pin that is selectively opened and closed to inject a raw material into a mold includes a housing in which a stator is disposed, a rotor disposed in the housing, the rotor acting with the stator to rotate, a rotational shaft coupled to the inside of the rotor, a screw assembly coupled in the rotational shaft, the screw assembly including a screw that linearly moves according to the rotation of the rotational shaft, and a control unit disposed on a side of the rotational shaft, the control unit comprising a detecting unit configured to detect a rotation amount or angle of the rotational shaft.

### TECHNICAL FIELD

Embodiments relate to a valve motor device of an injection molding apparatus.

### BACKGROUND ART

In general, injection molding apparatuses are used to mold various components to be mass-produced through an injection molding process in which thermoplastic raw materials are heated and melted and then injected into a mold from a nozzle at a high pressure. Such an injection molding apparatus may include an injection device configured to inject a raw material, such as a nozzle or the like, and a valve device configured to open or close the nozzle according to whether the raw material is injected.

FIG. 1 illustrates constitutions of an injection molding apparatus according to the related art.

An injection molding apparatus according to the related art includes a fixed mold 2 fixed at a predetermined position and a movable mold 3 that is movable toward the fixed mold 2. In a state that the movable mold 3 moves to be coupled or adjacent to the fixed mold 2, an injection part 8 having a shape corresponding to that of a product to be manufactured by the injection molding is formed between the fixed mold 2 and the movable mold 3. A predetermined raw material is injected to manufacture a product having a desired shape.

The fixed mold 2 includes a raw material supply part 4 into which a resin-type raw material is supplied, a flow path 5 along which the raw material injected from the raw material supply part 4 flows, and a nozzle 6 communicating with the flow path 5 and extending toward the injection part 8. An injection hole 7 through which the raw material is injected toward the injection part 8 is formed in an end of the nozzle 6.

The nozzle 6 includes a valve pin 9 that is provided as a “valve” or “valve device” that is linearly movable to selectively open and close the injection hole 7.

The fixed mold 2 further includes a motor device 10 supplying a driving force for the movement of the valve pin 9. The motor device 10 includes a driving part including a stator and a rotor and a rotational shaft 11 that is rotatable together with the rotor.

The motor device 10 further includes a coupler 12 coupled to the rotational shaft 11 and a pin holder 13 connecting the coupler 12 to the valve pin 9. The coupler 12 and the pin holder 13 may be screw-coupled to each other, and the pin holder 13 may linearly move while the coupler 12 rotates in a predetermined direction.

That is, the rotational movement of the rotational shaft 11 may be converted into linear movement through the coupler 12 and the pin holder 13, and the valve pin 9 coupled to the pin holder 13 may linearly move together with the pin holder 13.

FIG. 1 illustrates a state in which the valve pin 9 closes the injection hole 7. In this state, when the motor device 10 is driven to allow the rotor to rotate in a predetermined direction, the valve pin 9 may move upward with respect to FIG. 1 by the power transmission of the coupler 12 and the pin holder 13.

When the valve pin 9 moves upward, the injection hole 7 may be opened, and the raw material may be injected into the injection part 8 through the opened injection hole 7.

According to the injection molding apparatus of the related art, the coupler and the pin holder are separately required to convert the rotational movement of the motor device into the linear movement of the valve pin, and thus the motor device may increase in volume by the coupler and the pin holder.

In addition, as the motor device increases in volume, the fixed mold for accommodating the motor device may increase in size, resulting in increase of material costs expended for manufacturing a mold.

### DISCLOSURE OF INVENTION

### Technical Problem

Embodiments provide a valve motor device of an injection molding apparatus having improved operation reliability through a simple structure thereof.

### SOLUTION TO PROBLEM

In one embodiment, a valve motor device of an injection molding apparatus, which drives a valve pin that is selectively opened and closed to inject a raw material into a mold includes: a housing in which a stator is disposed; a rotor disposed in the housing, the rotor acting with the stator to rotate; a rotational shaft coupled to the inside of the rotor; a screw assembly coupled in the rotational shaft, the screw assembly comprising a screw that linearly moves according to the rotation of the rotational shaft; and a control unit disposed on a side of the rotational shaft, the control unit comprising a detecting unit configured to detect a rotation amount or angle of the rotational shaft.

The detecting device may include: a magnet disposed on the rotational shaft; and a magnet detecting part disposed on the outside of the magnet to detect the rotation amount or angle of the magnet.

The valve motor device may further include a magnet holder for fixing the magnet to the rotational shaft; and a coupling part defined in the rotational shaft, the coupling part being formed by recessing at least one portion of the rotational shaft to couple the magnet holder thereto, wherein, when the magnet holder is mounted in the coupling part, the magnet is disposed to face the magnet detecting part.

The control unit may include: a substrate on which the magnet detecting part is disposed; and a substrate mounting part for mounting the substrate on a side of the housing, wherein the substrate mounting part has a through-hole to allow the magnet to face the magnet detecting part.

The rotational shaft may include a recessed part into which the screw assembly is accommodated, and the screw assembly further includes a nut part coupled to the outside of the screw and is disposed in the recessed part to rotate with the rotational shaft.

A first screw thread may be disposed on an inner circumference surface of the nut part, and a second screw thread may be disposed on an outer circumference surface of the screw so that the second screw thread is interlocked with the first screw thread to guide the linear movement of the screw.

The valve motor device may further include a coupling pin passing through the screw; and a coupling guide part having a cutoff portion for guiding movement of the coupling pin.

The coupling pin may extend in a direction perpendicular to an extension direction of the screw.

The cutoff portion may be disposed on each of one side and the other side of the coupling guide part.

The valve motor device may further include a stopper disposed on the screw, wherein a stopper interference part interfering with the stopper while the screw linearly moves is disposed on one surface of the recessed part.

The screw may further include: a valve pin coupling part having a screw thread to which the valve pin is coupled; and a fixing member disposed on the valve pin coupling part to fix the coupling pin to the screw.

The screw may further include: a valve pin coupling part having a screw thread to which the valve pin is coupled; and a fixing member disposed on the valve pin coupling part to fix the coupling pin to the screw.

The valve motor device may further include a front cover disposed on one side of the housing and to which the valve pin is coupled; and a rear cover disposed on the other side of the housing and to which the control unit is coupled.

A first bearing may be disposed on one side of the rotor to surround the rotational shaft, thereby supporting the rotational shaft; and a second bearing may be disposed on the other side of the rotor to surround the rotational shaft, thereby supporting the rotational shaft.

The first bearing may be disposed inside the rear cover, and the second bearing may be disposed inside the front cover.

A spacer may be further disposed on an outer surface of the rotational shaft to surround at least one portion of the rotational shaft and space the rotor from the second bearing.

In another embodiment, a valve motor device of an injection molding apparatus, which drives a valve pin that opens and closes an injection hole for injecting a raw material into a mold, the valve motor device includes: a housing in which a stator having a coil is disposed; a rotor disposed in the housing, the rotor acting with the stator to rotate; a rotational shaft coupled to the inside of the rotor; a nut part fixed in the rotational shaft to rotate together with the rotational shaft; a screw screw-coupled to the inside of the nut part to linearly move, the screw being coupled to the valve pin; a magnet disposed on an end of the rotational shaft; a magnet detecting part disposed to face the magnet, thereby detecting a rotation amount or angle of the magnet; and a control part determining a linear movement distance of the screw to correspond to the rotation amount or angle of the magnet when the rotational shaft rotates.

The valve motor device may further include a power supply part for supplying a power to the coil, wherein control part controls an on/off operation of the power supply part.

The valve motor device may further include a timer for elapsing time after the screw moves to allow the valve pin to open the injection hole.

The valve motor device may further include a coupling pin coupled to pass through the screw; and a coupling guide part having a cutoff portion into which the coupling pin is inserted.

### ADVANTAGEOUS EFFECTS OF INVENTION

In the valve motor device according to the embodiment, the screw assembly may be accommodated in the rotational shaft and, and the screw may stably linearly move according to the rotation of the rotational shaft.

In detail, the screw assembly may include the nut part coupled to the rotational shaft and the screw screw-coupled to the nut part, and the screw coupling member provided on the screw may be guided by the coupling guide part of the bearing cover to prevent the screw from being shaken while linearly moving and from rotating undesirably.

Also, since the valve pin may be directly coupled to the screw to linearly move together with the screw, the motor device may have a compact size.

As the motor device is compact, the mold in which the motor device is installed may decrease in size to reduce the material costs required for manufacturing the mold.

Also, since the stopper is disposed on the end of the screw accommodated in the rotational shaft, the interference between the recessed part of the rotational shaft and screw may occur while the screw linearly moves to prevent the rotational shaft or the screw from being damaged.

In addition, since the magnet is disposed on the end of the rotational shaft, and the magnet detecting part configured to detect the rotation value or amount of the magnet is provided at a position facing the magnet, the motor device may be precisely controlled in driving.

### BRIEF DESCRIPTION OF DRAWINGS

FIG. 1 is a view of an injection molding apparatus provided in a motor device according to the related art.

FIG. 2 is a view illustrates an exterior of a valve motor device according to an embodiment.

FIGS. 3 and 4 are exploded perspective views of the valve motor device according to an embodiment.

FIG. 5 is a cross-sectional view of the valve motor device according to an embodiment.

FIG. 6 is a block diagram of the valve motor device according to an embodiment.

FIG. 7 is a cross-sectional view illustrating an operation of the valve motor device according to an embodiment.

### MODE FOR THE INVENTION

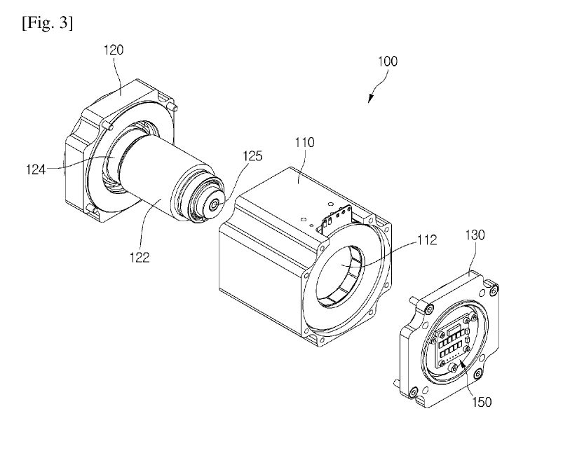

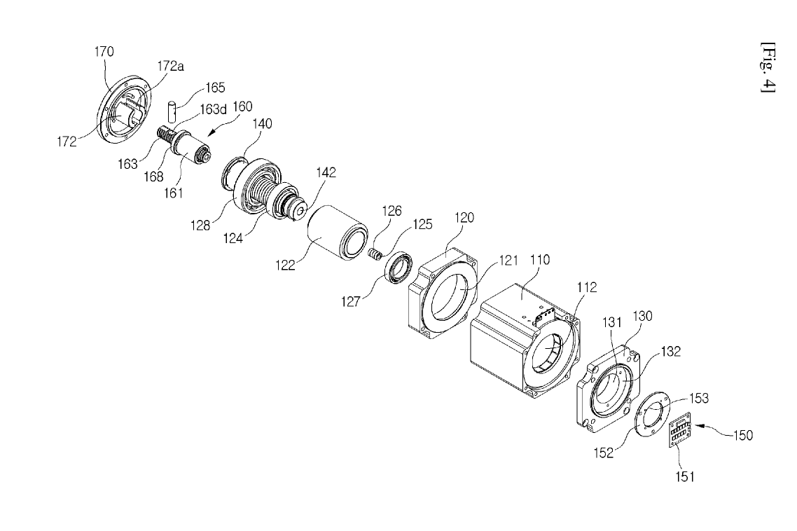

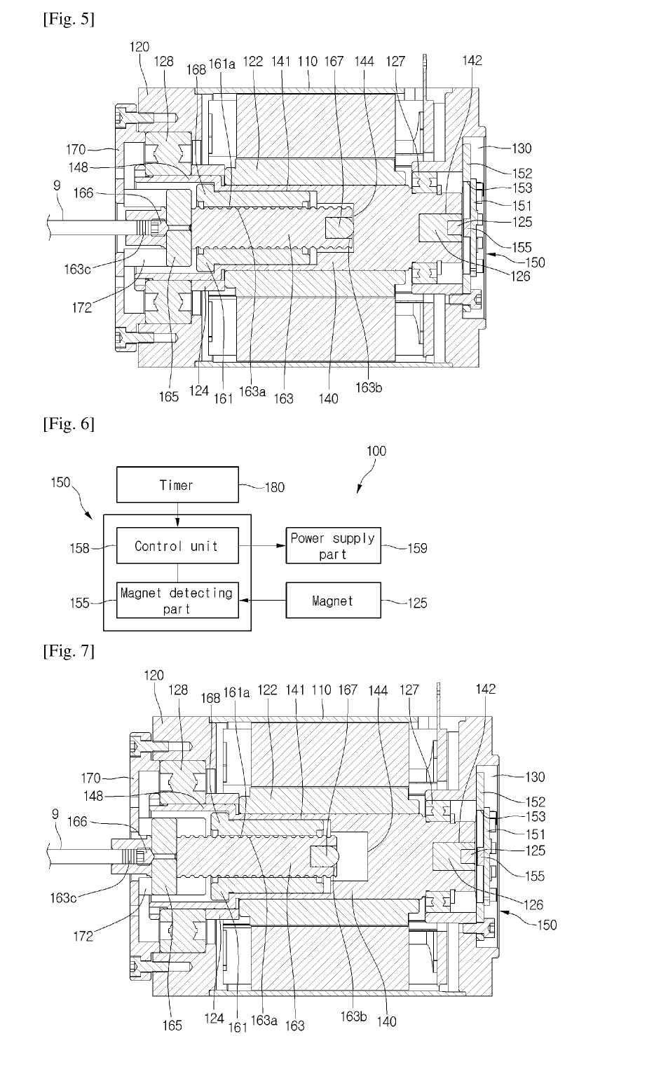

Hereinafter, exemplary embodiments will be described in detail with reference to the accompanying drawings. The technical ideas of the present disclosure are not limited to the following embodiments, and the technical ideas of the present disclosure may be modified into various modifications within the scope of the appended claims. FIG. 2 is a view illustrates an exterior of a valve motor device according to an embodiment, FIGS. 3 and 4 are exploded perspective views of the valve motor device according to an embodiment, and FIG. 5 is a cross-sectional view of the valve motor device according to an embodiment.

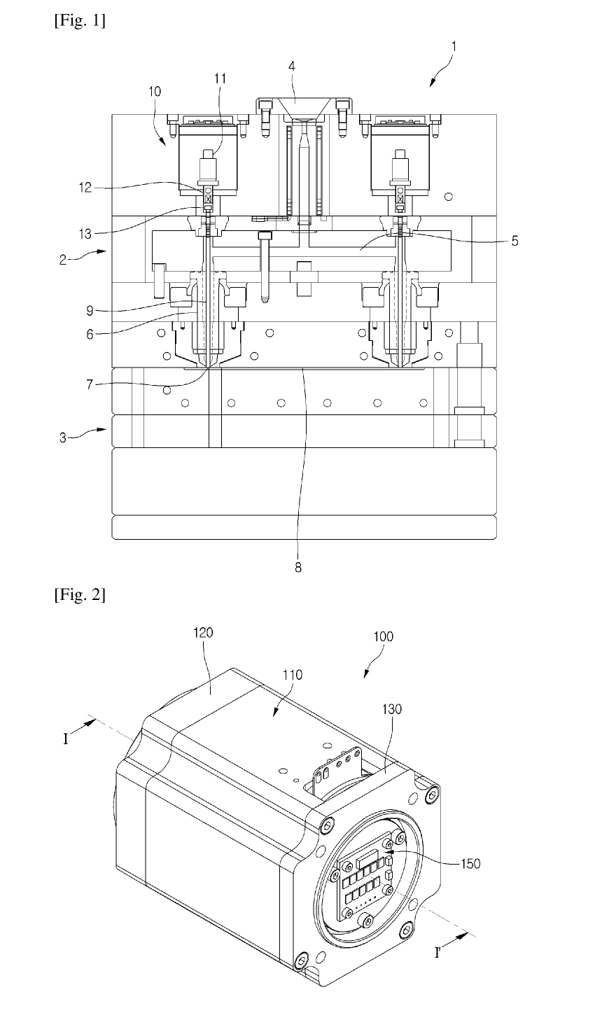

An injection molding apparatus according to an embodiment quotes a configuration of FIG. 1, but it should be understood that constitutions of a motor device is different from those according to the related art.

Referring to FIGS. 2 to 5, a valve motor device 100 (hereinafter, referred to as a motor device) according to an embodiment includes a housing 110 in which a stator 112 is disposed, a front cover 120 installed on a front side of the housing 110 and to which the valve pin 9 is connected, and a rear cover disposed on a rear side of the housing 110 and to which a control unit 150 is coupled.

The stator 112 and the rotor 122 are called a “driving part”.

In this specification, a front direction such as “front side” or “front end” may be understood as a direction from the motor device toward the valve pin, and a rear direction such as “rear side” or “rear end” may be understood as the opposite direction of the “front side” and “front end”. A direction perpendicular to the front direction and rear direction is called a “radial direction”.

In detail, the housing 110 has a cylindrical or prismatic shape to accommodate the stator 112 therein. The housing 110 has opened front and rear ends to allow a rotational shaft 140 to pass therethrough. The stator 112 may include a coil to which a power is applied.

The front cover 120 is coupled to the front side of the housing 110. In addition, the front cover 120 has a first cover through-hole 121 through which the rotational shaft 140 passes.

The rotor 122 may extend backward form the front cover 120 and be accommodated in the housing 110. In addition, the rotor 122 is rotatably disposed in the stator 112. When a power is applied to the coil of the stator 112, an electromagnetic force acts on the rotor 122 to allow the rotor 122 to rotate in a predetermined direction. The rotor 122 may rates in a clockwise or counterclockwise direction. That is, the rotor 122 may forwardly or reversely rotate.

The rotational shaft 140 is coupled to the inside of the rotor 122. The rotational shaft 140 together with the rotor 122 may rotate in the clockwise or counterclockwise direction.

A plurality of bearings 127 and 128 are disposed on both sides of the rotational shaft 140 to support the rotational shaft 140. The plurality of bearings 127 and 128 include a first bearing 127 disposed on a rear portion of the rotational shaft 140 and a second bearing 128 disposed on a front portion of the rotational shaft 140.

In detail, the first bearing 127 may be disposed on a front side of the rotor 122 to surround the rotational shaft 140, and the second bearing 128 may be disposed on a rear side of the rotor 122 to surround the rotational shaft 140.

Also, the first bearing 127 may be supported on the inside of the rear cover 130, and the second bearing 128 may be supported on the inside of the front cover 120.

A spacer 124 for spacing the rotor 122 from the second bearing 128 is disposed on an outer surface of the rotational shaft 140. The spacer 124 has a ring shape to surround at least a portion of the rotational shaft 140.

A recessed part 141 in which a screw assembly 160 is accommodated is defined in the rotational shaft 140. The recessed part 141 is recessed backward from a front portion of the rotational shaft 140.

The screw assembly 160 include a nut part 161 coupled to the recessed part 141 and a screw 163 screw coupled to the nut part 161. The nut part 161 may be coupled to the outside of the screw 163.

A nut flange part 168 is disposed on a front portion of the nut part 161, and a shfat flange part 148 supporting the nut flange part 168 is disposed inside the rotational shaft 140. The shaft flange part 148 may protrude outward from the recessed part 141 in a radial direction and be coupled to the nut flange part 168.

first screw thread 161a is formed on an inner circumference surface of the nut part 161. In addition, a second screw thread 163a interlocked with the first screw thread 161a is formed on an outer circumference surface of the screw 163.

The nut part 161 may be coupled to the rotational shaft 140 to rotate in the same direction as the rotational shaft 140 according to the rotation of the rotational shaft 140. When the nut part 161 rotates, the first screw thread 161a and the second screw thread 163a may be interlocked with each other to allow the screw 163 to move forward or backward.

For instance, when the rotational shaft 140 and the nut part 161 rotate in the clockwise direction, the screw 163 may move backward. When the rotational shaft 140 and the nut part 161 rotate in the counterclockwise direction, the screw 163 may move forward.

The motor device 100 may further include a coupling pin 165 coupled to the screw 163. The coupling pin 165 may pass through a through-hole 163d of the screw 163 to extend in a radial direction. The through-hole 163d may radially extend within the screw 163 to correspond to the extension direction of the coupling pin 165.

The extension direction of the coupling pin 165 may be approximately perpendicular to that of the screw 163.

A fixing member 166 for fixing the coupling pin 165 to the screw 163 is disposed on a front portion of the coupling pin 165. The fixing member 166 may be provided as a screw member and thus be screw-coupled to a valve pin coupling part 163c.

A bearing cover 170 defining a front exterior of the motor device 100 is disposed on a front portion of the screw. Also, the motor device 100 includes a coupling guide part 172 protruding backward from the bearing cover 170.

The coupling guide part 172 may have a cutoff portion 172a in which the coupling pin 165 is inserted. The cutoff portion 172a may be formed by cutting at least a part of the coupling guide part 172. Also, the cutoff portion 172 may be provided in plurality in one side and the other side of the coupling guide part 172. For instance, in FIGS. 4 and 5, the one side may be an upper portion, and the other side may be a lower portion.

While the screw 163 moves forward or backward, the coupling pin 165 may be inserted into the cutoff portion 172a to move.

Since the screw 163 may move by the coupling guide part 172 while the coupling pin 165 moves along the cutoff portion 172a, rotation and shaking of the screw 163 may be prevented.

A stopper 167 for preventing the screw 163 and the rotational shaft 140 from interfering with each other while the screw 163 linearly moves may be disposed on the screw 163. Also, the screw 163 has a mount groove 163b in which the stopper 167 is mounted. The mount groove 163b is recessed forward from a rear end of the screw 163.

The stopper 167 slightly protrudes backward from a rear end of the screw 163 in the state which the stopper is installed in the mount groove 163b. The stopper 167 may be formed of a material that is capable of easily absorbing shocks, for example, an elastically deformable material.

The rotational shaft 140 includes a stopper interference part 144 capable of contacting the stopper 167. The stopper interference part 144 may define one side of the recessed part 141 to contact the screw 163 when the screw 163 moves backward.

A valve pin coupling part 163c to which the valve pin 9 is coupled is disposed on a front portion of the screw 163. The valve pin coupling part 163c is recessed backward from a front portion of the screw 163. Also, a screw thread may be formed on the valve pin coupling part 163c so that the valve pin coupling part 163c is screw-coupled to the valve pin 9. The valve pin 9 may be coupled to the valve pin coupling part 163c to extend toward the injection hole 7 (see reference numeral 7 of FIG. 1).

However, according to another embodiment, a separate holder may be coupled to the valve pin coupling part 163c, and the valve pin 9 may be coupled to the holder.

A magnet 125 may be coupled to the rotational shaft 140.

In detail, the motor device 100 includes a magnet 125 having magnetism and capable of rotating together with the rotational shaft 140 and a magnet holder 126 fixing the magnet 125 to the rotational shaft 140.

A coupling part 142 to which the magnet holder 126 is coupled is disposed on the rotational shaft 140. The coupling part 142 is recessed forward from a rear end of the rotational shaft 140. When the magnet holder 126 is coupled to the coupling part 142, the magnet 125 is disposed to face the control unit 150.

A second cover through-hole 131 into which the rotational shaft 140 is inserted is defined in the rear cover 130. The second cover through-hole 131 passes through from a front surface to a rear surface of the rear cover 130.

A seat part 132 on which the control unit 150 is seated is disposed on the rear cover 130control unit. The seat part 132 has a flat surface on a rear side of the second cover through-hole 131.

In detail, the control unit 150 includes a substrate 151 and a substrate mounting part 152 for mounting the substrate 151 on the rear cover 130. A magnet detecting part 155 for detecting a rotation amount or angle of the magnet 125 may be disposed on the substrate 151. The magnet detecting part 155 may be disposed on the substrate in the form of a chip.

The magnet 125 and the magnet detecting part 155 are called a “detecting unit”.

The substrate mounting part 152 may be seated on the seat part 132. As described above, the seat part 132 may have a flat surface to stably fix the substrate seat part 152.

Also, a through-hole 153 through which the magnet 125 is exposed to the magnet detecting part 155 is defined in the substrate seat part 152. The substrate seat part 152 has an approximately ring shape by the through-hole 153. That is, the magnet 125 and the magnet detecting part 155 are disposed to face each other through the through-hole 153.

FIG. 6 is a block diagram of the valve motor device according to an embodiment.

Referring to FIG. 6, the control unit 150 according to an embodiment includes a control part 158 for controlling an on/off operation of a power supply part 159 to a power on the coil of the stator 112 and the magnet detecting part 155 for detecting the rotation amount or angle of the magnet 125 to transmit the detected rotation amount or angle to the control part 158.

The power supply part 159 may supply bidirectional current to the coil. For instance, when the power supply part 159 supplies the current to the coil in one direction, the rotor 122 may rotate forward. On the other hand, when the power supply part 159 supplies the current, the rotor 122 may rotate reversely. When the rotor 122 forward rotates, the valve pin 9 may move to open the injection hole 7. When the rotor 122 reversely rotates, the valve pin 9 may move to close the injection hole 7.

The motor device 100 further include a timer 180 to add up an elapsing time after the movement of the screw 163 so as to open the injection hole 7.

A control operation according to an embodiment will now be briefly explained.

When a power is applied to the coil of the stator 112 through the power supply part 159, a rotational force is given to the rotor 122 by electromagnetic fields. When the rotor 122 rotates in a predetermined direction, the rotational shaft 140 and the nut part 161 may integrally rotate.

As the nut part 161 rotates, when the first screw thread 161a and the second screw thread 163a may be interlocked with each other to rotate, the screw 163 may move forward or backward.

The magnet 125 rotates together with the rotational shaft 140 and the nut part 161.

Accordingly, the rotation amount or angle of the magnet 125 may correspond to that of each of the rotational shaft 140 and nut part 161. Here, the rotation amount and angle may be detected by the magnet detecting part 155.

As illustrated in FIGS. 4 and 5, since the magnet 125 and the magnet detecting part 155 are disposed to face each other with the through-hole 153 therebetween, the rotation amount or angle of the magnet 125 may be easily detected by the magnet detecting part 155.

Also, the rotation amount or angle of the nut part 161 may be converted into a linear movement distance of the screw 163 by the control part 158.

As a result, when a predetermined rotation amount or angle of the magnet 125 is detected, the rotation amount or angle of the magnet 125 may be converted into a linear movement distance of the screw 163. Thus, information with respect to a moving distance of the valve pin 9 may be obtained.

When the valve pin 9 moves a predetermined distance to open and close the injection hole 7, the power supply through the power supply part 159 may be stopped to stop the operations of the driving parts 112 and 122.

The timer 180 may add up the elapsing time in the state that the operations of the driving parts 112 and 122 are stopped. When the add-up time reaches a preset time, the driving parts 112 and 122 may be driven again to control the movement of the valve pin 9 again.

That is, when the preset time elapses after the valve pin 9 moves to open the injection hole 7, the valve pin 9 may move to close the injection hole 7.

FIG. 7 is a cross-sectional view illustrating an operation of the valve motor device according to an embodiment.

Referring to FIGS. 1, 5, and 7, when the driving parts 112 and 122 are driven, the rotational shaft 140 and the nut part 161 rotate in a predetermined direction, and thus the screw 163 moves forward or backward.

For instance, when the nut part 161 rotates in the clockwise direction, i.e., rotates forward, the screw 163 may move backward. When the nut part 161 rotates in the counterclockwise direction, i.e., rotates reversely, the screw 163 may move forward.

Also, as described above, the moving distance of the nut part 161 may be determined to correspond to the rotation amount or angle of the magnet 125.

For instance, when the rotor 122 rotates forwardly and reversely, the nut part 161 moves forward or backward. In this state, when the rotation amount or angle of the magnet 125 reaches a preset amount or angle, the operations of the driving parts 112 and 122 may be stopped. Here, the moving distance of the nut part 161 may be preset to correspond to the preset amount or angle.

While the screw 163 moves forward or backward, the coupling pin 165 moves along an inner space of the cutoff portion 172a. That is, the coupling pin 165 may be guided by the coupling guide part 172 to linearly move to prevent the screw 163 from rotating or being shaken.

When the screw 163 moves up to a rear limit position thereof, the stopper 167 may interfere with one surface of the recessed part 141 of the rotational shaft 140, i.e., the stopper interference part 144. Accordingly, it may prevent the screw 163 from directly colliding with the rotational shaft 140, thereby preventing the screw 163 and the rotational shaft 140 from interfering with each other while the motor device 100 is repeatedly driven.

The term “limit position” may be understood as a position at which the rear end of the screw 163 interferes with the stopper interference part 144 of the rotational shaft 140 due to a control error.

When the screw 163 moves backward, the valve pin 9 may move to open the injection hole 7. When the injection hole 7 is opened, a raw material flowing into a flow path 5 may be supplied into the injection part 8 through the injection hole 7 and then injection-molded in a predetermined shape.

When a preset amount of raw material is supplied into the injection molding part 8, that is, an opening time of the valve pin 9 reaches a predetermined time, the rotor 122 may reversely rotate.

Here, the opening time of the valve pin 9 may be added up by the timer 180.

As the rotor 122 reversely rotates, the rotational shaft 140 and nut part 161 may rotate in the counterclockwise direction, and thus the screw 163 may move forward.

When the screw 163 moves forward, the valve pin 9 may also move forward, and thus the valve pin 9 may move to a position at which the injection hole 7 is closed.

When the injection hole 7 is closed, the supply of the raw material into the injection part 8 through the injection hole 7 may be stopped.

According to the above-described constitutions and operations, the motor device may be simplified in structure. Therefore, the mold in which the motor device is installed may decrease in size, and also, material costs required for manufacturing the mold may be reduced.

In addition, the operation of the motor device may precisely controlled by the interaction between the magnet and the magnet detecting part to improve quality of the mold product that is manufactured through the injection molding apparatus.

### INDUSTRIAL APPLICABILITY

In the valve motor device according to the embodiment, since the screw assembly is accommodated into the rotational shaft, the screw stably linearly moves according to the rotation of the rotational shaft, the industrial applicability is remarkable.

1. A valve motor device of an injection molding apparatus, which drives a valve pin that is selectively opened and closed to inject a raw material into a mold, the valve motor device comprising:
a housing in which a stator is disposed;
a rotor disposed in the housing, the rotor acting with the stator to rotate;
a rotational shaft coupled to an inside of the rotor;
a screw assembly coupled in the rotational shaft, the screw assembly comprising a screw that linearly moves according to the rotation of the rotational shaft; and
a control unit disposed on a side of the rotational shaft, the control unit comprising a detecting unit configured to detect a rotation amount or angle of the rotational shaft.

2. The valve motor device according to claim 1, wherein the detecting unit comprises:
a magnet disposed on the rotational shaft; and
a magnet detecting part disposed on the outside of the magnet to detect the rotation amount or angle of the magnet.

3. The valve motor device according to claim 2, further comprising:
a magnet holder for fixing the magnet to the rotational shaft; and
a coupling part defined in the rotational shaft, the coupling part being formed by
recessing at least one portion of the rotational shaft to couple the magnet holder thereto,
wherein, when the magnet holder is mounted in the coupling part, the magnet is disposed to face the magnet detecting part.

4. The valve motor device according to claim 2, wherein the control unit comprises:
a substrate on which the magnet detecting part is disposed; and
a substrate mounting part for mounting the substrate on a side of the housing,
wherein the substrate mounting part has a through-hole to allow the magnet to face the magnet detecting part.

5. The valve motor device according to claim 1, wherein the rotational shaft comprises a recessed part into which the screw assembly is accommodated, and the screw assembly further comprises a nut part coupled to the outside of the screw and disposed in the recessed part to rotate with the rotational shift.

6. The valve motor device according to claim 5, wherein a first screw thread is disposed on an inner circumference surface of the nut part, and a second screw thread is disposed on an outer circumference surface of the screw so that the second screw thread is interlocked with the first screw thread to guide the linear movement of the screw.

7. The valve motor device according to claim 1, further comprising:
a coupling pin passing through the screw; and
a coupling guide part having a cutoff portion for guiding movement of the coupling pin.

8. The valve motor device according to claim 7, wherein the coupling pin extends in a direction perpendicular to an extension direction of the screw.

9. The valve motor device according to claim 7, wherein the cutoff portion is disposed on each of one side and the other side of the coupling guide part.

10. The valve motor device according to claim 5, further comprising a stopper disposed on the screw, wherein a stopper interference part interfering with the stopper while the screw linearly moves is disposed on one surface of the recessed part.

11. The valve motor device according to claim 7, wherein the screw further comprises:
a valve pin coupling part having a screw thread to which the valve pin is coupled; and
a fixing member disposed on the valve pin coupling part to fix the coupling pin to the screw.

12. The valve motor device according to claim 1, wherein the screw further comprises:
a valve pin coupling part having a screw thread to which the valve pin is coupled; and
a fixing member disposed on the valve pin coupling part to fix the coupling pin to the screw.

13. The valve motor device according to claim 1, further comprising:
a front cover disposed on one side of the housing and to which the valve pin is coupled; and
a rear cover disposed on the other side of the housing and to which the control unit is coupled.

14. The valve motor device according to claim 13, further comprising:
a first bearing disposed on one side of the rotor to surround the rotational shaft, thereby supporting the rotational shaft; and
a second bearing disposed on the other side of the rotor to surround the rotational shaft, thereby supporting the rotational shaft.

15. The valve motor device according to claim 14, wherein the first bearing is disposed inside the rear cover, and
the second bearing is disposed inside the front cover.

16. The valve motor device according to claim 14, further comprising a spacer disposed on an outer surface of the rotational shaft to surround at least one portion of the rotational shaft and spacing the rotor from the second bearing.

17. A valve motor device of an injection molding apparatus, which drives a valve pin that opens and closes an injection hole for injecting a raw material into a mold, the valve motor device comprising:
a housing in which a stator having a coil is disposed;
a rotor disposed in the housing, the rotor acting with the stator to rotate;
a rotational shaft coupled to the inside of the rotor;
a nut part fixed in the rotational shaft to rotate together with the rotational shaft;
a screw screw-coupled to the inside of the nut part to linearly move, the screw being coupled to the valve pin;
a magnet disposed on an end of the rotational shaft;
a magnet detecting part disposed to face the magnet, thereby detecting a rotation amount or angle of the magnet; and
a control part determining a linear movement distance of the screw to correspond to the rotation amount or angle of the magnet when the rotational shaft rotates.

18. The valve motor device according to claim 17, further comprising a power supply part for supplying a power to the coil, wherein control part controls an on/off operation of the power supply part based on the linear movement distance of the screw.

19. The valve motor device according to claim 17, further comprising a timer for elapsing time after the screw moves to allow the valve pin to open the injection hole.

20. The valve motor device according to claim 17, further comprising:
a coupling pin coupled to pass through the screw; and
a coupling guide part having a cutoff portion into which the coupling pin is inserted.
